(19) United States
(12) Patent Application Publication
(10) Pub. No.: US 2005/0099303 A1
(43) Pub. Date: May 12, 2005

(54) Injection molded garment hanger

(76) Inventor: Andrew M. Zuckerman, New York, NY (US)

Correspondence Address: AMSTER, ROTHSTEIN & EBENSTEIN LLP, 90 PARK AVENUE, NEW YORK, NY, 10016, US

(21) Appl. No.: 10/705,139

(22) Filed: Nov. 11, 2003

(51) Int. Cl. G08B 13/14

(52) U.S. Cl. 340/572.8; 223/85; 235/375

(57) ABSTRACT

A garment hanger for supporting at least one garment thereon, the garment hanger including: a. a one-piece injection molded plastic body having front and rear surfaces, top and bottom edges and opposite ends and an elongated arm extending outward from each of the opposite ends, b. a hook extending upward from the top edge of the body, c. an RFID tag integrally molded “in situ” into the body and embedded in the body between and inward from the front and rear surfaces respectively and between and inward the top and bottom edges respectively, d. the plastic having properties which preclude the RFID tag between the front and rear surfaces and between the top and bottom edges from being visible to the human eye, and e. the RFID tag being programmable to receive, store and transmit data relating to the garment hanger and/or to a garment supported thereon.

### FIELD OF THE INVENTION

This invention is in the field of injection molded plastic garment hangers and more particularly mass produced garment hangers used for large numbers of different sizes and styles of garments.

### BACKGROUND OF THE INVENTION

In the apparel industry large numbers of garments on hangers are frequently moved between manufacturing, storage and retail locations, and within these locations it is often necessary to identify, inventory and relocate specific garments or specific groups of garments on the basis of style, color, size, quality, age, price, source, destination, and/or other factors.

It is well known to identify and locate such garments by attaching to each individual garment an electronic tag or marker which contains electronically retrievable information about any or all of the above-listed factors. Such electronic devices additionally or alternatively function as anti-theft devices to activate alarms or alert monitors that garments are being moved toward an exit without having been purchased or otherwise cleared for exit.

Electronic tags function in various ways, including responding to electronic interrogation, providing product information without external activation, setting off alarms and transmitting signals to merely identify their locations or to provide information from which their locations may be ascertained. Well known examples of the latter include Lojack® anti-theft devices for vehicles, E-Z Pass® apparatus for vehicular traffic control, global positioning systems (“GPS”) devices used for a variety of personal, commercial and military purposes and electronic article surveillance (“EAS”) devices used in retail stores when attached to garments.

Usually, the EAS devices cannot be removed without a special apparatus situated at a check-out terminal. Attempts to remove such EAS devices without using the special apparatus will either destroy or damage the garments or alert store security of an attempt to remove or disable the EAS devices.

Prior art patents described below and incorporated herein by reference disclose various electronic inventory control devices, including radio frequency identification (RFID) devices, electronic article surveillance (EAS) devices, and anti-theft devices, all attachable to many varieties of articles. Typical devices are clearly visible to persons handling the goods, be they garments, hangers, cartons or other items.

U.S. Pat. No. 5,738,255 to Wilms discloses a garment hanger with an electronic information storage device connected to a fastening device which is fixed onto a garment. This fastening device can only be removed from the garment by a special tool. This electronic information storage device, typically a read-only memory (ROM) or a programmable memory (PROM) on an IC chip, provides information about the garment or the hanger and may also serve to trigger an alarm.

U.S. Pat. No. 6,142,347 to Kolton et al. discloses an anti-theft EAS device positioned in a recess in a hanger, which recess is subsequently covered in an attempt to hide the device. Not only does this require added steps in manufacture, but evidence of the cover is suggestive that an EAS is hidden within the hanger.

U.S. Pat. No. 5,785,181 to Quartararo discloses a button-sized RFID tag permanently fixed to a garment being handled in a garment dry cleaning establishment. This tag has information such as owner name, date, reason for cleaning, etc. Each time the garment is deposited with the cleaner the RFID tag is automatically read by a tag reader near the garment conveyer. The computer maintains a history on each garment, keyed to the garment identification number in the RFID tag.

U.S. Pat. No. 6,354,493 to Mon relates generally to RFID tags for inventory, tracking and control, and more particularly for locating specific RFID tagged articles from a plurality of articles. An RFID tag which is attached to each article that is desired to be inventoried or tracked stores data associated with the article. An RFID reader scans for tags by transmitting an interrogation signal at a known frequency. The RFID tag responds to the interrogation signal with a response signal that contains data associated either with the article or with the RFID tag itself. The RFID reader detects the response signal and decodes the data.

Additional prior art patents of interest in the field of RFID technology include U.S. Pat. Nos. 5,859,587, 6,142,347, 6,169,483, 6,356,197B1, 6,429,776 B1, and 6,449,991 B1, all incorporated herein by reference.

### SUMMARY OF THE NEW INVENTION

While an individual plastic hanger is quite inexpensive, the garment industry uses millions of these hangers laden with garments every day, which calls for major inventory tracking and control efforts, often using electronic devices such as EAS, RFID and GPS devices. Since many of these hangers are removed from use when they are given to retail customers at the time of purchase, or when they become separated from their intended garments, or when they become damaged or lost, huge numbers of replacement hangers must be made, and the cost of such mass production becomes critical. Thus, even an apparently minor improvement in manufacturing efficiency will have a major impact on annual costs.

The new invention is an improved garment hanger and method of manufacturing same, with numerous benefits for hanger manufacturers and for users of hangers, namely garment manufacturers, wholesalers, retailers and transporters. Obviously, these new hangers may be used to hang accessories and other articles. In the new hangers the RFID or other EAS devices are totally hidden and thus avoid problems associated with these devices being visible to users. Also, each device causes no projection from the hanger surface and thus avoids problems where the device would interfere with safe and efficient placement of garments on hangers and removal of garments from hangers. Also, such a hidden device causes no distraction from the appearance and presentation of the garment. Furthermore, these devices themselves are now safe from damage. Finally, the manufacturing costs are significantly reduced.

Beginning with manufacture, the new method eliminates three steps, namely (a) the step of establishing a specific recess in each injection mold cavity to receive the RFID tag, (b) the step in a later operation of inserting the RFID tag into the recess space, and (c) the step thereafter of applying and securing a cover to close the recess to seal and hide the tag.

In the new invention the RFID tag is positioned in the mold cavity prior to injection of the hanger body. Thus, no separate recess need be designed into the hanger body to later receive an electronic device. Instead, in a single injection step, the hanger body is formed with the RFID tag embedded in the hanger body. Furthermore, without appropriate electronic apparatus this tag is invisible to users and customers, partially because the plastic is colored or otherwise not transparent, and partially because the tag, being fully embedded, causes no protrusions in the surface of the hanger. There is not even a seam line to suggest a hidden tag, since there has been no cover attached over the tag. Of course, this tag could also be used with a hanger made of clear plastic. A still further benefit of the non-protruding RFID tag is that it causes no interference with placement of the garment on or removal of the garment from the hanger. It is inherent in this construction that the tag is permanently located in the hanger, and that it is secure from damage or removal. As noted earlier, such tag is invisible and secret, and this causes no visible distraction from the garment's presentation.

This new garment hanger and RFID tag combination can be easily programmed and re-programmed, and finally it is less expensive to manufacture this hanger than to make prior hangers with RFID tags attached later. Hangers utilizing this invention may have curved or straight arms, large, small or absent neck portions, integrally molded or added top hooks, and any combination of hooks and projections extending from the arms or slots on the hanger for releasably securing garments thereon.

It is thus an object of this invention to provide an injection molded plastic garment hanger that has molded into its body an RFID tag which (a) is completely contained and optionally invisible within said body portion, and (b) cannot be removed from said body portion without causing major damage or destruction to said hanger, and (c) is devoid of protrusions from the body portion surface due to said RFID tag therein which would interfere with garments being placed on or removed from the hanger.

It is a further object to provide such a new garment hanger where the RFID tag is molded into the body portion by placement of the tag in the injection mold cavity to form the body portion prior to injection of the liquid plastic. Accordingly, it is a further object to have RFID tag sealed within the hanger body portion with no requirement of placement of the tag into a recess in a hanger body after the hanger is made, no requirement of a later applied cover, and no seam lines to evidence the presence of a cover or suggest the presence of an RFID tag therein. While the central portion as the arms of the body are the most suitable places for receiving the RFID tag, the hook portion is an option in hangers where the hook is integrally molded as part of the hanger body. Furthermore, the invention as disclosed herein may be used in various articles other than in hangers.

It is an additional object for the RFID tag to include any selected combination of data including but not limited to identification of the hanger and/or a garment thereon by style, size, material, source of manufacture, source of storage, history of travel and use, and any other data useful for inventory, sorting, accounting and, of course, inclusion of anti-theft and security history features.

Accordingly, a preferred embodiment of the present invention may be described as a garment hanger for supporting at least one garment thereon, said garment hanger comprising:
a. a one-piece injection molded plastic body having front and rear surfaces, top and bottom edges and opposite ends and an elongated arm extending outward from each of said opposite ends,
b. a hook extending upward from said top edge of said body,
c. an RFID tag integrally molded into said body at the time said body is molded, and embedded in said body between and inward of said front and rear surfaces and between and inward of said top and bottom edges, and
d. said RFID tag being programmable with data relating to said garment hanger and/or to a garment supported thereon.

The foregoing and other objects and features of the invention will be further evident from the following detailed description of preferred embodiments thereof and from the drawings.

### BRIEF DESCRIPTION OF THE DRAWINGS

FIG. 1 is a front elevational view of first preferred embodiment of the new garment hanger,

FIG. 2 is an enlarged sectional view taken along line 2-2 of FIG. 1,

FIG. 3 is a fragmentary front elevational view of a second embodiment of the new garment hanger, and

FIG. 4 is an enlarged sectional view taken along line 4-4 of FIG. 3.

### DESCRIPTION OF THE PREFERRED EMBODIMENTS

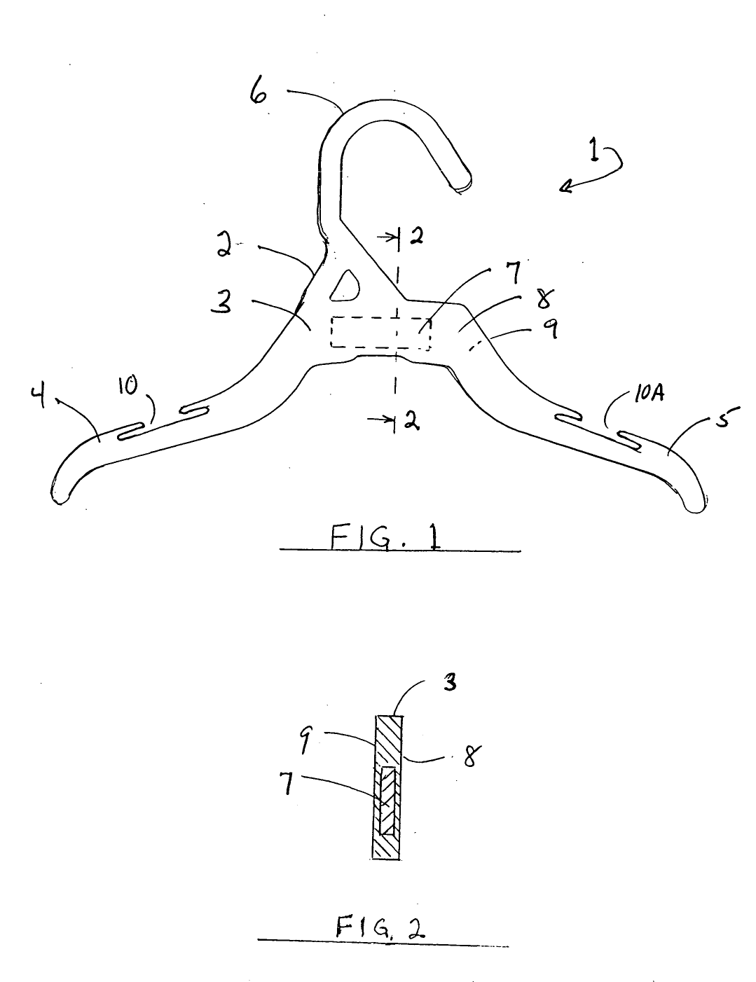

A first embodiment of the new garment hanger 1 shown in FIG. 1 comprises a body 2 which includes a central portion 3, left and right arms 4, 5, a hook 6 and an RFID tag 7 shown by dashed lines, as it is completely embedded in central portion 3. FIG. 2 further illustrates the RFID tag 7 embedded between and inward of front and rear surfaces 8 and 9 respectively, and between and inward of the top and bottom edges of said central portion 3. This hanger includes garment-engaging slots 10 and 10A in arms 4 and 5 respectively.

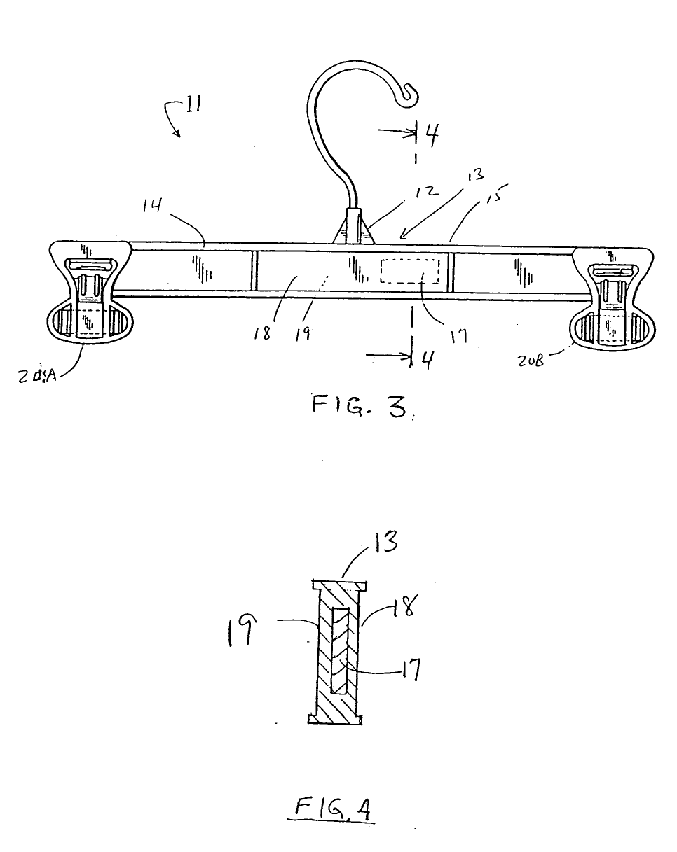

FIGS. 3 and 4 illustrate a second embodiment showing hanger 11, neck 12, central portion 13 of the hanger body, and straight arms 14, 15. The RFID tag 17 is fully embedded between and inward of front and rear surfaces 18 and 19 respectively and between and inward of the top and bottom edges of central portion 13. This hanger includes garment-engaging clamps 20A, 20B, these being merely representative of many types of garment-engaging hooks, slots and clamp elements used on hangers.

The RFID tags 7 and 17 in FIGS. 1, 2 and 3, 4 respectively may also have a variety of shapes, so long as they are fully embedded, invisible to the human eye and secured from damage caused by normal use.

These hangers are made by injection molding in multi-cavity molds by well known molding techniques using plastics common in the industry, including but not limited to nylon, polyethylene, polypropylene, PVC and others, to produce garment hangers having adequate strength for the intended purpose of supporting garments of various weights.

As described with reference to FIGS. 1-4, the RFID tags 7 and 17 respectively are fully embedded within the front and rear surfaces such that the RFID tags cause no protrusions from said surfaces which might evidence or suggest the presence of an RFID or other EAS device within the hanger. To insure that the RFID tag is not visible, at least to the human eye, the plastic used to form the hanger body is either colored or sufficiently opaque that the tag cannot be seen.

The RFID tags are of the types known in the industry and as typified by prior art patents cited above. In the present invention the tag will be programmed to receive and store data of interest to the user which may include data associated (a) with the identity of the hanger including styles, size, color, age, etc., (b) with the manufacturing history of the hanger, (c) with the travel history of the hanger, (d) with the garment associated with the hanger, (e) with inventory control information, (f) with security data associated with the hanger, and (g) with any other data deemed relevant to the user.

Later, at selected times and locations an RFID reader transmits an interrogation signal and receives from an RFID tag the data requested, depending on the search criteria, or simply receives confirmation of the presence of the RFID tag.

In the manufacturing stage of the present invention, it is contemplated that appropriate fixtures or robotic elements would be used for placement of the RFID tags in the mold cavities prior to injection of the liquid plastic. Data may be imputed into these tags both prior to the molding stage and, of course, later when a specific usage or changed data has been determined.

While the invention has been described with respect to preferred embodiments, it will be understood by those skilled in the art that various changes may be made without departing from the spirit, scope or teaching of the invention. Accordingly, the invention herein disclosed is to be limited only as specified in the following claims.

1. A garment hanger for supporting at least one garment thereon, said garment hanger comprising:
a. a one-piece injection molded plastic body having front and rear surfaces, top and bottom edges and opposite ends and an elongated arm extending outward from each of said opposite ends,
b. a hook extending upward from said top edge of said body, and
c. an RFID tag integrally molded “in situ” into said body and embedded in said body between and inward from said front and rear surfaces respectively and between said top and bottom edges,
d. said RFID tag being programmable to receive, store and transmit data relating to said garment hanger and/or to a garment supported thereon.

2. A garment hanger according to claim 1 wherein front and rear surfaces and said top and bottom edges are each contiguous and devoid of projections in the surfaces thereof which could evidence the presence of said RFID tag between said surfaces and edges.

3. A garment hanger according to claim 1 wherein said front and rear surfaces define respectively generally flat, parallel, spaced apart planes.

4. A garment hanger according to claim 1 wherein said front and rear surfaces are devoid of any protrusions extending outwardly of said surfaces corresponding in shape to said RFID tag embedded between said surfaces.

5. A garment hanger according to claim 1 wherein said hook comprises an extension of said body integrally molded therewith.

6. A garment hanger according to claim 5 wherein said RFID tag is molded into said hook.

7. A garment hanger according to claim 1 wherein said RFID tag is permanently molded into and sealed within said body.

8. A garment hanger according to claim 1 wherein said RFID tag embedded between said top and bottom edges is situated inward of said edges respectively.

9. A garment hanger according to claim 1 wherein said RFID tag is programmable and reprogrammable subsequent to it's being molded into said body.

10. A garment hanger according to claim 1 wherein said body comprises plastic selected from the group comprising nylon, polypropylene, PVC and polyethylene.

11. A garment hanger for supporting at least one garment thereon, said garment hanger comprising:
a. an injection molded plastic body having front and rear surfaces, top and bottom edges and opposite ends and an elongated arm extending outward from each of said opposite ends,
b. a hook extending upward from said top edge of said body, and
c. a programmable electronic storage device integrally molded in situ into said body and embedded in said body between and inward of said front and rear surfaces respectively and between and inward of said top and bottom edges respectively,
d. said programmable electronic storage device adapted to receive, store and transmit data relating to said garment hanger and/or to a garment supported thereon.

12. A garment hanger according to claim 10 wherein said plastic has properties which preclude said programmable electronic device between said front and rear surfaces and between said top and bottom edges from being visible to the human eye.

13. A garment hanger for supporting at least one garment thereon, said garment hanger comprising:
a. a one-piece injection molded plastic body having front and rear surfaces, top and bottom edges and opposite ends and an elongated arm extending outward from each of said opposite ends,
b. a hook extending upward from said top edge of said body, and
c. an RFID tag integrally molded “in situ” into said body and embedded in said body between and inward from said front and rear surfaces respectively and between and inward from said top and bottom edges respectively, and
d. said plastic having properties which preclude said RFID tag between said front and rear surfaces and between said top and bottom edges from being visible to the human eye, and
e. said RFID tag being programmable to receive, store and transmit data relating to said garment hanger and/or to a garment supported thereon.

14. A hanger for supporting at least one article thereon, said hanger comprising:
a. a one-piece injection molded plastic body having front and rear surfaces, top and bottom edges and opposite ends and an elongated arm extending outward from each of said opposite ends,
b. a hook extending upward from said top edge of said body, and
c. an RFID tag integrally molded “in situ” into said body and embedded in said body between and inward from said front and rear surfaces respectively and between said top and bottom edges,
d. said RFID tag being programmable to receive, store and transmit data relating to said hanger and/or to an article supported thereon.

15. A garment hanger according to claim 14 wherein said hook comprises an extension of said body integrally molded therewith.

16. A garment hanger according to claim 15 wherein said RFID tag is molded into said hook.

17. A method of making a garment hanger for supporting at least one garment thereon, where said garment hanger includes a one-piece injection molded plastic body having front and rear surfaces, top and bottom edges and opposite ends and an elongated arm extending outward from each of said opposite ends, a hook extending upward from said top edge of said body and an RFID tag integrally molded into said body and embedded in said body between and inward from said front and rear surfaces respectively and between and inward from said top and bottom edges respectively, said method comprising the steps:
a. forming an injection mold which includes a plurality of cavities, each cavity defining a garment hanger and including a space within said cavity for receiving an RFID tag to be situated between said front and rear surfaces,
b. situating said RFID tag in said space within said cavity, and
c. injecting said plastic into said mold cavity to form said garment hanger and to embed said RFID tag between said front and rear surfaces of said body of said hanger, whereby said RFID tag is integrally molded into said body at the time said hanger body is molded.

18. A method according to claim 17 wherein said plastic has properties which preclude said RFID tag between said surfaces and between said top and bottom edges from being visible to the human eye.

19. A method of electronically storing data in and subsequently retrieving data from an injection molded plastic garment hanger, where said garment hanger has a body formed of a central portion and arms extending from said central portion, with front and rear surfaces and top and bottom edges of said body, and a hook extending upward from said body, said method comprising:
a. embedding an RFID device in said body of said garment hanger by molding said RFID device “in situ” in said body with said RFID device situated between and inward of said front and rear surfaces and between said top and bottom edges, when said garment hanger is injection molded,
b. electronically inputting into said RFID device selected data pertaining to said garment hanger and/or to a garment attached to said garment hanger, and
c. subsequently, electronically activating and interrogating said RFID device to respond and transmit requested data.

20. A method according to claim 19, wherein said step of embedding said RFID device further comprises situating said RFID device inward of said top and bottom edges respectively.

21. A method according to claim 19, comprising the further step of programming said RFID device after it has been molded into said garment hanger.

22. A method according to claim 19, comprising the further step of hiding said RFID device from view by users of said garment hanger by molding with non-transparent colored plastic.
